(19) United States
(12) Patent Application Publication
(10) Pub. No.: US 2013/0294623 A1
(43) Pub. Date: Nov. 7, 2013

(54) High Performance Transducer

(71) Applicants: Andy Askew, Winston-Salem, NC (US); Dale Yarbrough, Winston-Salem, NC (US); Gregory Lyon, Winston-Salem, NC (US); Stanley Przybylowicz, Winston-Salem, NC (US)

(72) Inventors: Andy Askew, Winston-Salem, NC (US); Dale Yarbrough, Winston-Salem, NC (US); Gregory Lyon, Winston-Salem, NC (US); Stanley Przybylowicz, Winston-Salem, NC (US)

(21) Appl. No.: 13/933,380

(22) Filed: Jul. 2, 2013

Related U.S. Application Data
(63) Continuation-in-part of application No. 12/678,229, filed on Sep. 2, 2010, now abandoned.

(51) Int. Cl. H04R 1/42; G05D 16/20

(52) U.S. Cl. CPC H04R 1/42; G05D 16/2066
USPC 381/165; 251/129.15

(57) ABSTRACT

Systems and methods for a high performance transducer are disclosed. For example, one described transducer includes: a pressure locking chamber with at least one orifice; a two-state solenoid configured to be controlled by a control circuit and a capacitor, the two-state solenoid comprising a solenoid housing; and a permanent magnet assembly configured to be actuated by the two-state solenoid to move between an open and a closed position, the permanent magnet assembly comprising a stopper configured to seal the at least one orifice in the closed position.

### CROSS REFERENCE TO RELATED APPLICATIONS

This application is a Continuation-in-Part of U.S. patent application Ser. No. 12/678,229, filed on Sep. 2, 2010, entitled “High Performance Transducer,” which is a national phase filing of PCT/US08/58440, filed on Mar. 27, 2008, and entitled “High Performance Transducer,” which claims priority to Provisional Application No. 60/921,195, filed Mar. 30, 2007, and entitled “High Performance Transducer,” the entirety of all of which is hereby incorporated by reference herein.

### BACKGROUND

Transducers are often used in locations where there is a high probability of external power loss. This power loss will disrupt the control signal, thereby interrupting the output pressure of the transducer. There are many situations where this loss of pressure is either undesirable or potentially hazardous. Therefore, there is a need for a transducer with a fail-safe system which is adapted to maintain output pressure despite loss of control signal.

### SUMMARY

The present disclosure relates generally to pressure transducers, and more specifically to electro-pneumatic transducers adapted to maintain operating pressure in the event of signal loss.

Some embodiments of the present disclosure relate to an electro-pneumatic pressure locking mechanism comprising: a pressure locking chamber with at least one orifice; a two-state solenoid configured to be controlled by a control circuit and a capacitor, the two-state solenoid comprising a solenoid housing; and a permanent magnet assembly configured to be actuated by the two-state solenoid to move between an open and a closed position, the permanent magnet assembly comprising a stopper configured to seal the at least one orifice in the closed position.

Some embodiments of the present disclosure relate to: an electro-pneumatic transducer for controlling gas pressure comprising: a volume booster chamber comprising an orifice nozzle and a volume booster assembly configured to control output pressure; a two-state solenoid configured to actuate a permanent magnet assembly to move between an open and a closed position, the permanent magnet assembly comprising a stopper configured to seal the orifice nozzle in the closed position, the two-state solenoid comprising a solenoid housing; and a control circuit configured to receive a control signal and configured to actuate the volume booster assembly based in part on the control signal.

Some embodiments of the present disclosure relate to: a method for controlling an electro-pneumatic transducer having a nozzle body and a valve housing interconnected by a nozzle, the method comprising the steps of: detecting whether a control signal is below a predetermined level; and when the control signal is below the predetermined level, triggering a capacitor to send a pulse to a two-state solenoid configured to actuate a permanent magnet assembly configured to move between an open and a closed position, the permanent magnet assembly comprising a stopper configured to seal at least one orifice of a pressure locking chamber when in the closed position.

These illustrative embodiments are mentioned not to limit or define the limits of the present subject matter, but to provide an example to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

FIG. 1 is a view of an electro-pneumatic transducer according to one embodiment of the present disclosure;

FIG. 2 is a cross-sectional view of an electro-pneumatic transducer according to one embodiment of the present disclosure;

FIG. 3 is a view of the electro-pneumatic transducer according to one embodiment of the present disclosure;

FIG. 4 is a view of the electrical enclosure of the electro-pneumatic transducer according to one embodiment of the present disclosure with parts disassembled;

FIG. 5A is a view of a solenoid assembly according to one embodiment of the present disclosure;

FIG. 5B is a cut-away view of a solenoid assembly according to one embodiment of the present disclosure;

FIG. 6 is a view of a stopper assembly according to one embodiment of the present disclosure;

FIG. 7A is cross-sectional view of a stopper assembly according to one embodiment of the present disclosure;

FIG. 7B is cross-sectional view of a stopper assembly according to another embodiment of the present disclosure; and

FIG. 8 is a flow chart illustrating a method for controlling the electro-mechanical transducer according to one embodiment of the present disclosure.

### DETAILED DESCRIPTION

For the purposes of this specification, unless otherwise indicated, all numbers used in the specification are to be understood as being modified in all instances by the term “about.” Accordingly, unless indicated to the contrary, the numerical parameters set forth in the following specification are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of this disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

### Illustrative Embodiment of a High Performance Transducer

An illustrative embodiment of the present disclosure comprises a transducer coupled to a booster chamber, the transducer having a nozzle which is configured to control the pressure of a gas. In the illustrative embodiment, a solenoid may be used to control a magnetic stopper assembly positioned in line with the nozzle. In the illustrative embodiment, when the solenoid is energized to generate a magnetic field having a predetermined polarity, it will actuate the stopper assembly to either allow or prevent the flow of gas through the nozzle.

In the illustrative transducer, the booster chamber also comprises an amplifying diaphragm coupled to a voice coil which controls the primary output pressure of the transducer. As the current supplied to the voice coil is increased, the pressure within the booster chamber increases accordingly.

The illustrative transducer comprises a control circuit coupled to a solenoid valve assembly and to the voice coil. In the illustrative transducer, the control circuit is configured to sense the voltage and/or current of a control signal, and vary the current and/or voltage applied to the voice coil based on the sensed voltage and/or current. For example, in one embodiment, the control circuit comprises a constant current driver that is configured to continuously supply the voice coil with a current that is a proportional fraction of the value of the current of the control signal. In some embodiments, this proportional fraction may be adjusted by the user or by a control circuit using a potentiometer, variac, or other circuit known in the art. In the illustrative transducer, as the voltage and/or current to the voice coil and suspension assembly is varied, the position of the voice coil is varied. This causes the primary output pressure of the transducer to vary.

In the illustrative transducer, the control circuit is further configured to detect a loss of the control signal, or a variance of the control signal outside a predetermined range, e.g., outside the range of 4 mA to 20 mA, or a percentage of that range, e.g., 10% below 4 mA, or 3.6 mA. When the control circuit detects that the control signal has been lost, or fallen outside the predetermined level (e.g., due to a power outage or surge), the control circuit responds to maintain the volume booster chamber pressure. The control circuit does so by triggering a capacitor to send an electrical signal to the solenoid to actuate the valve assembly. This causes the solenoid to close the valve, and thus maintain a fixed pressure in the booster chamber.

Further, in some embodiments, the control circuit may comprise a circuit configured to maintain the current to the voice coil at its last setpoint. For example, in one embodiment, the control circuit may measure the current received from an external source. In such an embodiment, the control circuit may be configured to act as an alternate power source in the event there is a loss of power from the external source. Further, the control circuit may be configured to maintain the current to the voice coil at a level substantially equal to its last level (e.g., its last setpoint). In some embodiments, for example, the control circuit may comprise a capacitor, inductor, battery, or some other circuit configured to store an electrical charge.

In the illustrative transducer, when the control circuit detects that the control signal is above the predetermined threshold, the control circuit charges the capacitor to a predetermined level. The circuit then triggers the capacitor to energize the solenoid to open the nozzle body and allow the pressure in the booster chamber to again vary.

In the illustrative transducer, the valve assembly comprises a permanent magnet configured to have a magnetic force strong enough to hold the magnet in its last position (e.g., either open or closed), without a further force being applied by the solenoid. This operation may be referred to as a “lock in last position” functionality that allows the transducer to lock the output pressure at the value in which the transducer was operating immediately prior to variance of the control signal. In some embodiments, the illustrative transducer further comprises a sealing and vent assembly configured to allow the transducer to be deployed in harsh environments.

### Systems for a High Performance Transducer

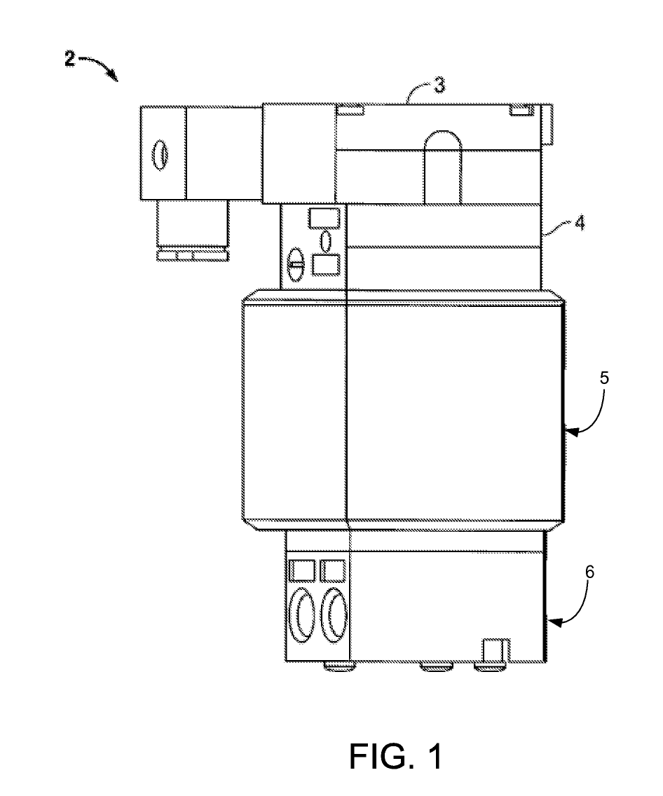

Turning now to the Figures, FIG. 1-FIG. 3 show views of an electro-pneumatic transducer 2 according to some embodiments of the present disclosure. In the embodiments shown in FIG. 1-FIG. 3, the electro-pneumatic transducer 2 comprises a nozzle body 4, which is disposed on top of a pressurized electrical enclosure assembly 5, and a valve body assembly 6.

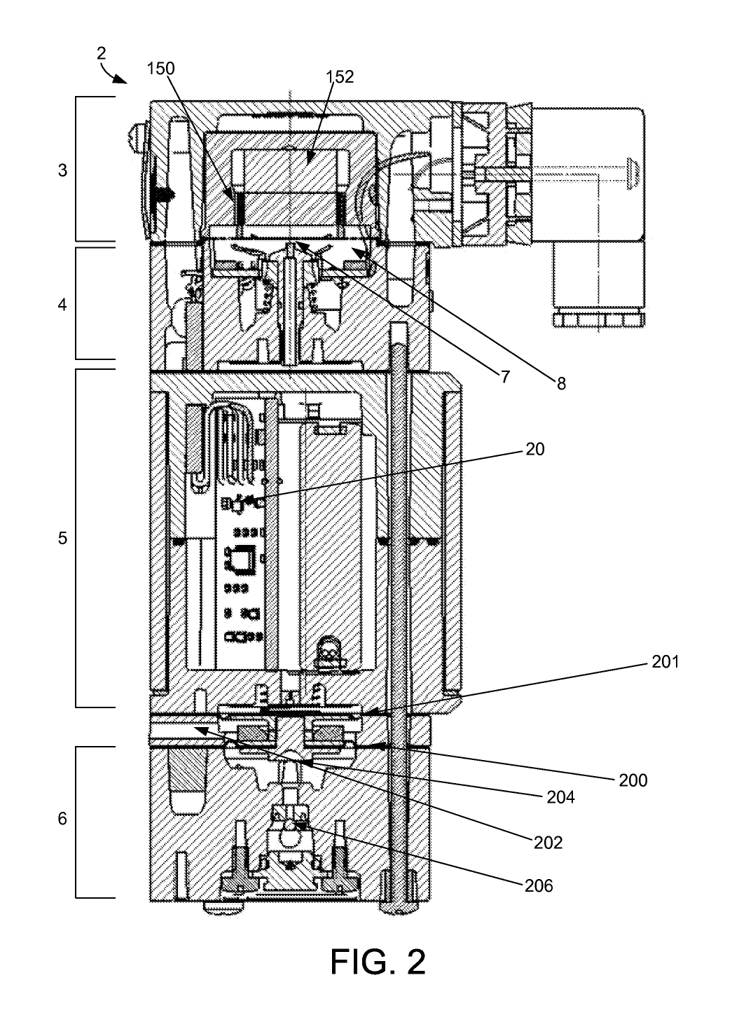

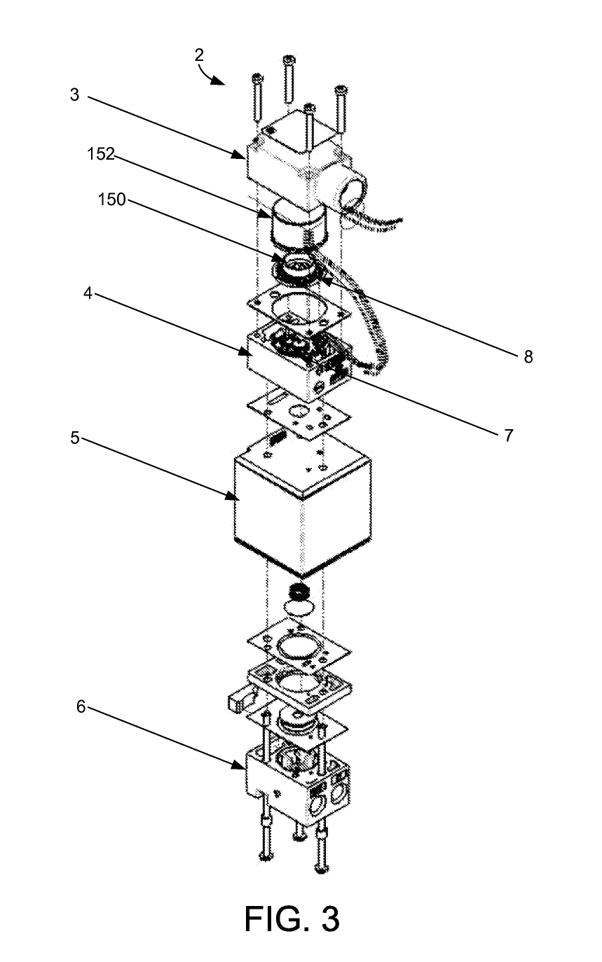

In the embodiments shown in FIG. 2 and FIG. 3, the electro-pneumatic converter section 3 comprises a voice coil and suspension assembly 150 comprising a magnet assembly 152. The voice coil and suspension assembly 150 may be any type of magnetically controlled diaphragm. In some embodiments, the voice coil and suspension assembly are configured to be the primary controller of the flow of gas into the electro-pneumatic transducer 2. In some embodiments, the gas may comprise, e.g., air, helium, hydrogen, oxygen, natural gas, methane, propane, one or more hydrocarbon(s), or other known gas.

The embodiments shown in FIG. 1-FIG. 3 also comprise a nozzle body 4. Gas travels thru nozzle body 4 and pressure may be controlled by the voice coil 150, spring 8, and nozzle 7 (shown in FIG. 2).

In the embodiments shown in FIG. 1 and FIG. 2, the electro-pneumatic transducer 2 comprises a pressurized electrical enclosure assembly 5 coupled to the valve body assembly 6. As shown in FIG. 2, the valve body assembly 6 comprises a control diaphragm 200 coupled to a booster vent 202, an exhaust valve 204, and a supply valve 206. In some embodiments, the signal diaphragm 201 leverages the pressure in the pressurized electrical enclosure assembly 5 to modify the configuration of the supply valve. In some embodiments, this modification of the configuration of the supply valve will similarly modify the supply pressure. In some embodiments, the pressure may be modified to be within a range (e.g., 10 psi) of a desired pressure value. In some embodiments, the modification is based on a control signal, and is configured to provide enhanced flow capacity, e.g., greater volume of flow, greater pressure, more accurate volume, or more accurate pressure.

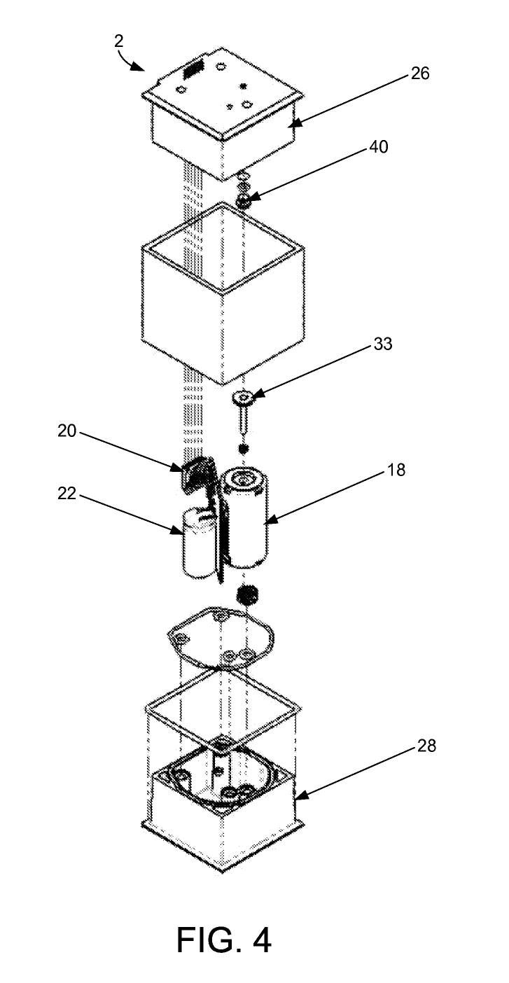

Turning now to FIG. 4, FIG. 4 shows one embodiment of a pressurized electrical enclosure assembly 5 comprising a solenoid assembly 18, a control circuit 20, and a capacitor 22. In the embodiment shown in FIG. 4, the pressurized electrical enclosure assembly 5 comprises a substantially rectangular shape; in other embodiments other shapes may be used. In some embodiments, the control circuit 20 is also coupled to the capacitor 22. In some embodiments, the capacitor 22 is recharged continually whenever the input signal is active. Further, in some embodiments, the capacitor 22 may comprise a battery, inductor, or other circuit configured to store electrical energy.

In some embodiments, the control circuit 20 receives an electrical input signal and transmits the input signal to the control circuit. In some embodiments, the input signal may be received from an external controller, e.g., a networked computer system or other controller. One example of a control circuit that can be used in some embodiments is a constant current driver circuit. In such an embodiment, the control circuit converts the input signals into an electrical signal for controlling the solenoid 18. More specifically, in some embodiments, the control circuit 20 supplies the voice coil 150 with a current that is proportional to the value of the current of the input signal, which is adjusted by an internal potentiometer. For example, in some embodiments, the control circuit 20 may comprise a constant current driver that continuously supplies the voice coil 150 with a current that is a proportional fraction of the value of the current of the incoming signal and may be adjusted by an internal or external potentiometer or other circuit. In other embodiments, other control circuits known to those of skill in the art could also be used.

In some embodiments, the control circuit 20 is also configured to sense when the input signal is outside a predetermined operational level. For example, in some embodiments, the control circuit 20 senses when the input signal drops below the minimum predetermined operational level. In some embodiments, the operational level may be a predetermined range (e.g., from about 4 mA to about 20 mA) and the signal deviation may be about 10% (e.g., 3.6 mA or 22 mA) below the minimum value of the predetermined range or above the maximum value of the predetermined range, e.g., due to a power outage, power surge, or some other disruption in the input signal.

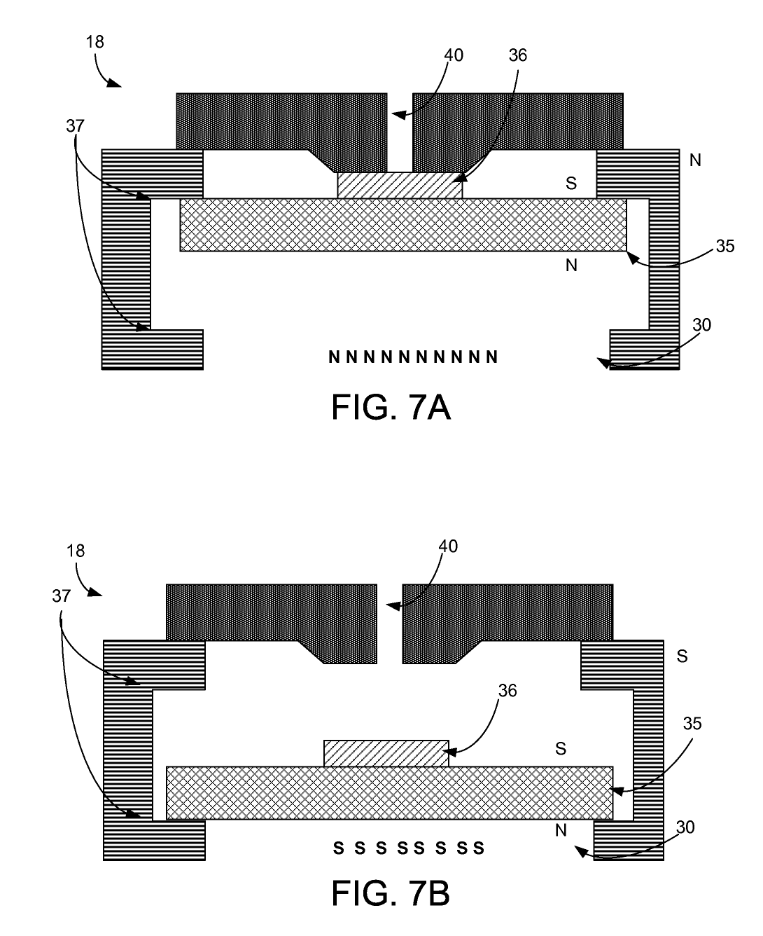

In some embodiments, when the control circuit 20 detects a drop in the input signal to a level below the predetermined threshold, the control circuit 20 may signal the capacitor 22 to discharge and energize the solenoid 18 (e.g. by outputting a negative or positive pulse to the solenoid 18). In some embodiments, this signal to the capacitor causes it to energize the solenoid 18 to temporarily assume a magnetic field in which the top portion of the solenoid 18 is of the same magnetic polarity as the bottom portion of the magnetic stopper assembly (described with more detail below with regard to FIG. 7A-7B).

Further, in such an embodiment, when the input signal recovers, the control circuit 20 recharges the capacitor 22. Once the capacitor 22 is sufficiently charged, the control circuit 20 may then transmit another electrical signal to the capacitor 22 so the capacitor discharges and provides a pulse to the solenoid 18. In some embodiments, this pulse may be configured to cause the solenoid 18 to temporarily assume a magnetic field in which the top portion of the solenoid 18 is of the opposite magnetic polarity as the bottom portion of the magnetic stopper, and thereby open the valve assembly.

In the embodiments described above, the stopper assembly may comprise a permanent magnet. Thus, the stopper assembly may apply a magnetic force to the solenoid housing strong enough to hold the magnetic stopper in its position (e.g., open or closed) once it has been actuated by the solenoid, even if the solenoid provides no further force to the magnetic stopper. In some embodiments, this may enable the system to operate at a very low power, because the solenoid may require only a small pulse to actuate the stopper assembly, which requires no further external force to hold in position.

The above functionality is an improvement over conventional electromechanical transducers, because during a signal loss, a conventional electromechanical transducer becomes inoperative because the signal loss prevents any control of the components of the transducer. However, a transducer of the present disclosure allows the output pressure to remain constant upon occurrence of signal loss. This improvement can be referred to as “lock in last position” functionality.

Turning now to FIG. 4, FIG. 4 shows another embodiment of the pressurized electrical enclosure assembly 5. As shown in FIG. 4, the pressurized electrical enclosure assembly 5 may comprise an upper valve housing 26 and a lower valve housing 28. In some embodiments, the lower valve housing 28 may comprise a lower cavity (not shown in FIG. 4) for at least partially enclosing the solenoid assembly 18, the control circuit 20, and the capacitor 22. In some embodiments, the upper valve housing 26, may further comprise an upper cavity (not shown in FIG. 4) for enclosing any portions of the solenoid assembly 18, the control circuit 20, and the capacitor 22 that extend from the lower valve housing 28.

### Solenoid and Magnetic Stopper Assembly for a High Performance Transducer

In some embodiments, design of the “lock in last place” transducer relies on an integrated solenoid valve module interposed between a flapper-nozzle pilot and the booster section. In some embodiments, upon signal failure, an electrical charge stored within a storage circuit (e.g., a capacitor, battery, or other charge storage circuit) coupled to a circuit controlling the solenoid valve module is used to maintain current to the voice coil at its last setpoint. Further, in such an embodiment, substantially simultaneously, a high energy pulse from a capacitor causes a solenoid valve to extend and seal against the nozzle, trapping the signal pressure within the signal chamber at the last setpoint. In such an embodiment, the volume booster continues to provide its normal forward and exhaust flow, with the constant signal pressure now captured and maintained within the signal chamber

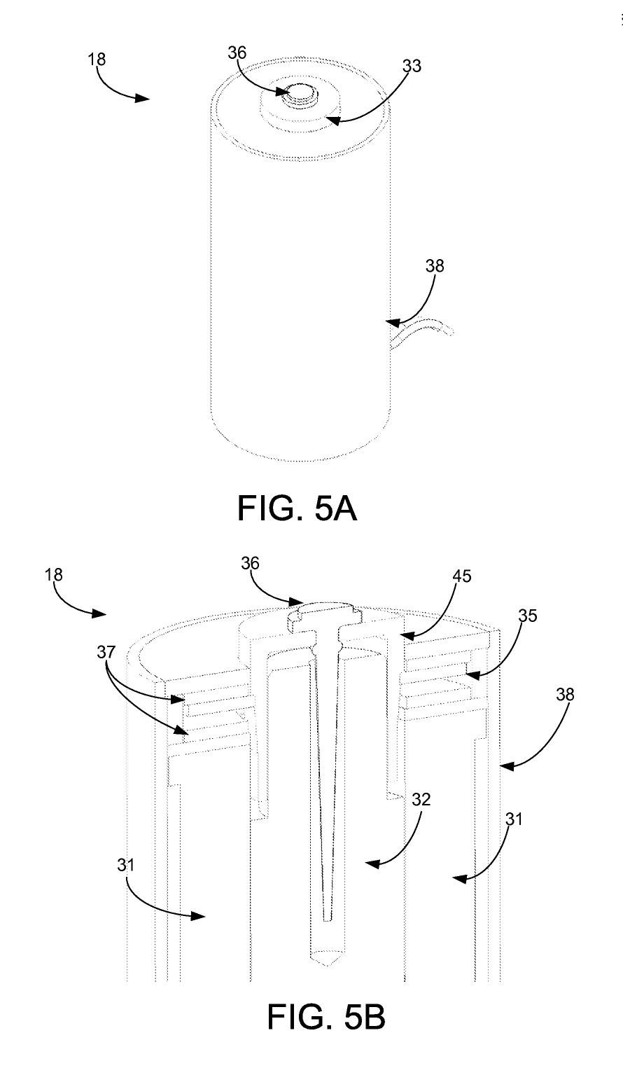

Turning now to FIG. 5A, FIG. 5A illustrates a view of a solenoid assembly 18, which comprises a magnetized valve assembly 33. In the embodiment shown in FIG. 5A, the magnetized valve assembly 33 comprises a stopper 36. In some embodiments, stopper 36 may be made out of rubber, silicon, plastic, or another material configured to form a seal. In some embodiments, the stopper 36 moves with the stopper assembly 33. Thus, in some embodiments, the stopper 36 is opened or closed against the nozzle 40 (described above with regard to FIG. 4) to either allow or block the flow of the supplied gas.

In some embodiments, the opening and closing of the stopper assembly 33 is controlled by changing the polarity of a magnetic pulse created by the solenoid assembly 18. As described above, the control circuit 20 controls the polarity of the solenoid assembly 18 by directing the current flow. In some embodiments, when the solenoid assembly 18 is powered by a first electric signal (e.g., a positive pulse), the top portion of the solenoid assembly 18 temporarily assumes one polarity (e.g., North) and the bottom portion assumes the opposite polarity (e.g., South). Similarly, when the control circuit 20 reverses the current flow by supplying a second electric signal (e.g., a negative pulse), the polarity of the solenoid assembly 18 is temporarily reversed.

In some embodiments, the solenoid assembly 18 comprises a two-state pulse activated solenoid, which comprises a housing 38 enclosing a coil 31(shown in FIG. 5B). When the coil is energized either by a positive or negative pulse (e.g., two-way activation), the coil generates a magnetic field in one of the two directions—with the top portion of the solenoid assembly 18 being either North or South and the bottom portion being of opposite polarity. The housing 38 also may be constructed from a material that transmits magnetic flux (e.g., steel, iron, or some other material).

Further, in some embodiments, not shown in FIG. 5A, the stopper assembly 33 may further comprise a spring holder disposed on top of the solenoid assembly 18. In some embodiments, the spring holder may comprise a spring, such as a compression spring, a coil spring, or a leaf spring, configured to apply pressure to the valve assembly

Turning now to FIG. 5B, FIG. 5B shows a cut-away view of a solenoid assembly 18 according to one embodiment of the disclosure. As shown in FIG. 5B, the solenoid assembly 18 comprises coil 31, core 32, permanent magnet 35, stopper 36, non-magnetic cup 45, and spacers 37.

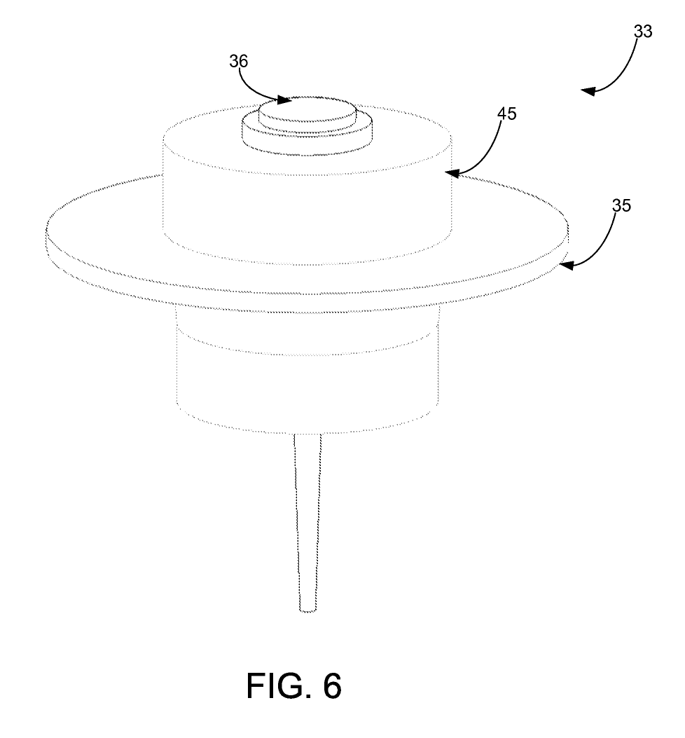

The permanent magnet 35 may comprise a magnet installed on a non-magnetic cup (described with regard to FIG. 6 below). In some embodiments, the permanent magnet may be installed with the North Pole facing down and the South Pole facing up. In such an embodiment, when the capacitor sends a positive pulse to the solenoid assembly 18, the current flowing through coil 31 creates a magnetic field in core 32. In such an embodiment, the upper part of the core may become the North Pole of the electromagnet. This attracts the South Pole of the permanent magnet 35 and may also repel the North Pole causing the magnet 35 (along with the non-magnetic cup 45 and stopper 36) to jump upward. This action forces the stopper 36 against the nozzle (described above with regard to FIG. 3) and creates a sealed pneumatic valve. In some embodiments, the solenoid may be configured to apply only a pushing or only pulling force on permanent magnet 35.

Further, in such an embodiment, when the capacitor sends a negative pulse to the solenoid assembly 18 (e.g., when the control signal returns to within the threshold, for example, because the power outage or surge has ended), the current flowing through coil 31 creates a magnetic field in the solenoid assembly 18. In such an embodiment, the upper part of the core becomes the South Pole of the electromagnet. This repels the South Pole of the permanent magnet 35 causing the magnet (along with the non-magnetic cup 45 and stopper 36) to jump downward. This action pulls the stopper 36 away from the nozzle (described above with regard to FIG. 3) and unseals the pneumatic valve.

The natural attraction of the permanent magnet 35 to the housing of the solenoid assembly 18 allows the stopper assembly to remain in either the up or down position until a pulse from the capacitor or control circuit causes it to move. The ability of the permanent magnet 35 to hold the stopper 36 in its last position (e.g., either up, sealing the nozzle, or down unsealing the nozzle) enables the transducer of the present disclosure to have a “lock in last position” functionality.

In the embodiment shown in FIG. 5B, spacers 37 define the range of motion of the permanent magnet. Further, spacers 37 are produced from a non-magnetic material (e.g., plastic, aluminum, rubber, etc.) to keep the permanent magnet 35 from getting too close to the metal at the top and bottom of the solenoid assembly 18. This prevents the permanent magnet from overpowering the force of the electromagnet and permanently attaching itself to the magnetic material (e.g., metal) at the top or bottom of its range of motion.

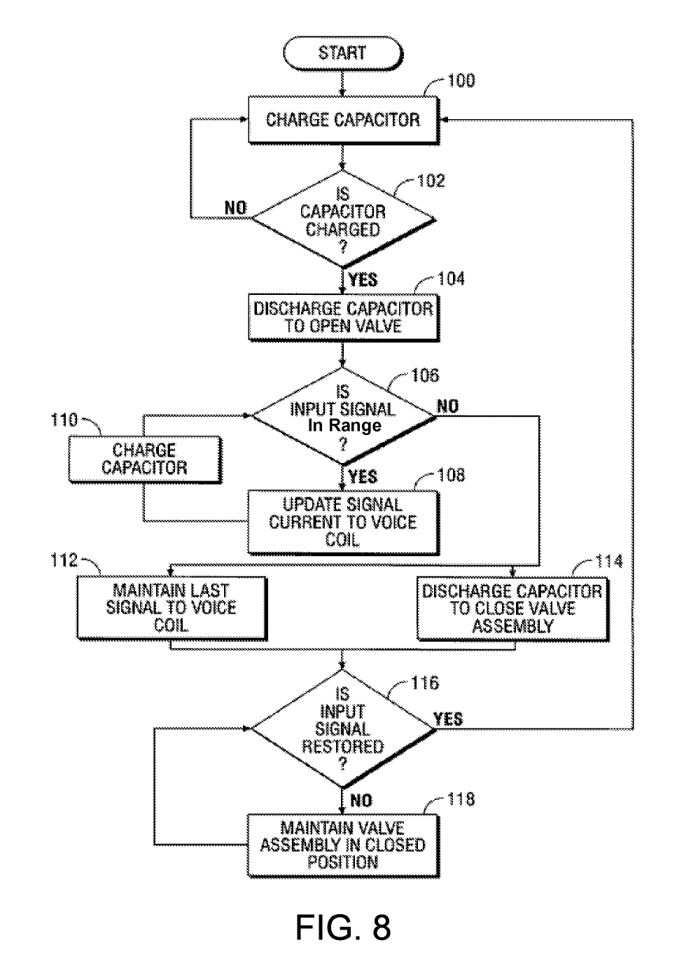

Turning now to FIG. 6, which shows a view of stopper assembly 33. As shown in FIG. 8, stopper assembly 33 comprises permanent magnet 35, stopper 36, and non-magnetic cup 45. As shown in FIG. 6, permanent magnet 35 comprises a disk or doughnut-shaped permanent magnet, though other shapes are possible. In the embodiment shown in FIG. 6, permanent magnet 35 is press fit onto a non-magnetic cup 45 that slips over the core material and transmits the motion of the magnet to the stopper 36. In some embodiments, non-magnetic cup 45 may be produced from plastic, rubber, silicon, or other non-magnetic materials known in the art.

### Diagrams of the Operations of High Performance Transducer

Turning now to FIG. 7A and 7B, FIG. 7A and 7B illustrate the operation of the solenoid assembly 18 according to one embodiment. The embodiment shown in FIG. 7A comprises the solenoid assembly 18 with the valve assembly in a closed configuration. The embodiment shown in FIG. 7B comprises the solenoid assembly 18 with the valve assembly in an open configuration. As shown in FIG. 7A and 7B, the valve assembly operates by opening and closing nozzle 40 with stopper 36. The nozzle 40 allows for the supplied gas to flow from the nozzle body 4 into the pressurized electrical enclosure assembly 5 to the booster chamber in the valve body assembly 6 (described above with regard to FIG. 1-4).

FIG. 7A depicts the valve assembly in the closed configuration, which occurs when the solenoid assembly 18 is powered by an electrical pulse (e.g., negative pulse). In this configuration, the polarity of the solenoid assembly 18 is temporarily reversed and the top portion of the solenoid assembly 18 is of the same polarity as the bottom portion of the permanent magnet 35. For example, as shown in FIG. 7A, the upper end of the solenoid assembly 18 temporarily assumes a North magnetic polarity and the permanent magnet is pushed and pulled to the top position. As a result, the permanent magnet is pushed upwards and contacts the nozzle 40 with the stopper 36 thereby blocking the flow of supplied gas. In some embodiments, the stopper 36 may further comprise a non-magnetic cup (not shown in FIG. 7A or 7B, but described above with regard to FIG. 6). By sealing the booster chamber, the transducer is effectively locked in the last place and maintains a constant output pressure.

FIG. 7B depicts the valve assembly in the open configuration, which occurs when the solenoid assembly 18 is powered by another electrical pulse (e.g., a positive pulse). In the configuration shown in FIG. 7B, the solenoid assembly 18 temporarily assumes a magnetic field in which the top portion of the solenoid assembly 18 is of the opposite polarity as the bottom portion of the permanent magnet 35. For example, in the embodiment shown in FIG. 7B, the upper end of the solenoid assembly 18 temporarily assumes a South magnetic polarity and the permanent magnet is pulled and pushed to the bottom position. As a result, the permanent magnet 35 is attracted toward the top portion of the solenoid assembly 18 thereby moving the stopper 36 from the nozzle 40 allowing for flow of the supplied gas. This causes the rubber stopper to disengage and the unit output is once again controlled by the input signal. The pressure in the booster chamber is allowed to vary and the capacitor is now charged in case the control signal again falls outside of the predetermined level (e.g., if there is another power outage or a power surge).

In the embodiments shown in FIG. 7A and 7B, the natural attraction of the permanent magnet 35 will allow the stopper assembly to remain in either the up or down position until a pulse from the capacitor or control circuit causes the solenoid assembly 18 to output a magnetic force. In some embodiments, this enables the disclosed transducer to operate in very low power situations, because the solenoid assembly 18 is only required to output short pulses to move the stopper assembly, which will subsequently hold itself in place. In the embodiments shown in FIG. 7A and 7B, spacers 37 are shown to keep the magnet from getting too close to the metal at the top and bottom of the stroke, and overpowering the force of the electromagnet.

### Method for Operating a High Performance Transducer

Turning now to FIG. 8, FIG. 8 shows the steps of a method for operating a high performance transducer according to one embodiment of the present disclosure. In some embodiments, one or more steps in the method may be skipped, or performed in a different order than shown in FIG. 8.

In step 100 when the input signal is within the operational range, the capacitor 22 is charged to a predetermined level. In some embodiments, the capacitor 22 may comprise a battery, inductor, or other circuit configured to store electrical energy. And in step 102, the control circuit 20 senses when the capacitor has been charged to a predetermined level.

In step 104, the control circuit 20 signals the capacitor 22 to discharge and provide an electrical signal (e.g., a positive pulse) to the solenoid assembly 18. The first electrical signal (e.g., a positive pulse) causes the solenoid assembly 18 to temporarily assume a magnetic field in which the top portion of the solenoid assembly 18 is opposite polarity of the bottom portion of the permanent magnet 35 thereby opening the valve assembly by pulling the stopper 36 away from nozzle 40, as discussed above with respect to FIG. 7B.

In step 106, the circuit 20 monitors the input signal to determine whether the input signal is within range. For example, the circuit 20 may monitor to determine if the input signal is present, or is above or below a threshold value (e.g., 4 mA). If yes, the method proceeds to step 108 and the circuit 20 updates the current of the signal to the voice coil 150. For example, in one embodiment, the control circuit 12 may update the current of the signal to be proportional to the input signal. In step 110, the control circuit maintains the charge on the capacitor. The method loops back to step 106 and continues to monitor the input signal.

If the input signal is below the threshold value (e.g., below 3.6 mA), the method branches to step 112 to maintain the last signal stored for the voice coil 150. The method substantially simultaneously executes step 114 and the control circuit 20 signals the capacitor to discharge and provide an electrical signal (e.g., a negative pulse) to the solenoid assembly 18. A pulse from the capacitor (e.g., a positive or negative pulse) causes the top portion of the solenoid assembly 18 to be of the same polarity as the bottom portion of the permanent magnet, 35, thereby closing the valve assembly 33 by pushing the stopper 36 toward nozzle 40 as discussed above with respect to FIG. 7A.

In step 116, the control circuit is ready to respond to the restoration of the input signal. If no signal is present, the previous closed configuration of the valve assembly 33 is maintained due to the natural attractive force of the permanent magnet 35. Upon restoration of the control signal, the method branches back to step 100 to start the process over, and at step 104, reopens the valve to allow the pressure in the booster chamber to vary.

### Advantages of a High Performance Transducer

There are numerous advantages of a High Performance Transducer according to various embodiments of the present disclosure. For example, some embodiments of the present disclosure may comprise better tolerance and higher precision because the use of a permanent magnet in some configurations does not require a spring. Springs can be “temperamental” as the spring constant may vary with age, wear and tear, or environmental conditions. Further, not all springs are produced to exact tolerances.

For these and other reasons, some embodiments of the present disclosure may be easier to manufacture and install and have a longer operational life. Such advantages may, in some embodiments, reduce the cost of construction as well as the cost of operation of a High Performance Transducer. This may lead to greater user adoption, as well as greater user satisfaction with the system in operation.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed is:

1. An electro-pneumatic pressure locking mechanism comprising:
a pressure locking chamber with at least one orifice;
a two-state solenoid configured to be controlled by a control circuit and a capacitor, the two-state solenoid comprising a solenoid housing; and
a permanent magnet assembly configured to be actuated by the two-state solenoid to move between an open and a closed position, the permanent magnet assembly comprising a stopper configured to seal the at least one orifice when in a closed position.

2. The electro-pneumatic pressure locking mechanism of claim 1, wherein the control circuit is configured to detect when a control signal falls below a predetermined level.

3. The electro-pneumatic pressure locking mechanism of claim 2, wherein when the control signal falls below a predetermined level, the control circuit is configured to direct a pulse from the capacitor to the two-state solenoid to move the permanent magnet assembly to the closed position.

4. The electro-pneumatic pressure locking mechanism according to claim 3, wherein the permanent magnet assembly is configured to maintain a closed position due to a magnetic force of the permanent magnet on the solenoid housing, until the two-state solenoid applies an electromagnetic force to the permanent magnet assembly.

5. The electro-pneumatic pressure locking mechanism of claim 3, wherein the control circuit is configured to direct a pulse from the capacitor to the two-state solenoid to move the permanent magnet assembly to an open position, upon the control signal returning to above the predetermined level.

6. The electro-pneumatic pressure locking mechanism according to claim 5, wherein the permanent magnet assembly maintains the open position due to a magnetic force of the permanent magnet on the solenoid housing, until the two-state solenoid applies an electromagnetic force to the permanent magnet assembly.

7. The electro-pneumatic transducer according to claim 2, wherein the predetermined level is 4 mA.

8. The electro-pneumatic transducer according to claim 1, wherein the capacitor comprises a battery.

9. An electro-pneumatic transducer for controlling gas pressure comprising:
a volume booster chamber comprising an orifice nozzle and a volume booster assembly configured to control output pressure;
a two-state solenoid configured to actuate a permanent magnet assembly to move between an open and a closed position, the permanent magnet assembly comprising a stopper configured to seal the orifice nozzle when in the closed position, the two-state solenoid comprising a solenoid housing; and
a control circuit configured to receive a control signal and configured to actuate the volume booster assembly based in part on the control signal.

10. The electro-pneumatic transducer of claim 9, wherein the control circuit is configured to detect when the control signal falls below a predetermined level.

11. The electro-pneumatic transducer of claim 10, further comprising a capacitor, and wherein the control circuit is configured to direct a pulse from the capacitor to the two-state solenoid to move the permanent magnet assembly to the closed position when the control signal falls below a predetermined level.

12. The electro-pneumatic transducer according to claim 11, wherein the permanent magnet assembly is configured to maintain the closed position due to a magnetic force of the permanent magnet on the solenoid housing until the two-state solenoid applies an electromagnetic force to the permanent magnet assembly.

13. The electro-pneumatic transducer of claim 11, wherein upon the control signal returning to above the predetermined level, the control circuit is configured to direct a pulse from the capacitor to the two-state solenoid to move the permanent magnet assembly to the open position.

14. The electro-pneumatic transducer according to claim 13, wherein the permanent magnet assembly maintains the open position due to a magnetic force of the permanent magnet on the solenoid housing, until the two-state solenoid applies an electromagnetic force to the permanent magnet assembly.

15. The electro-pneumatic transducer according to claim 10, wherein the predetermined level is 4 mA.

16. The electro-pneumatic transducer according to claim 10, further comprising, an orifice nozzle body and a valve housing interconnected therebetween by the orifice nozzle.

17. A method for controlling an electro-pneumatic transducer having a nozzle body and a valve housing interconnected by a nozzle, the method comprising the steps of:
detecting whether a control signal is below a predetermined level; and
when the control signal is below the predetermined level, triggering a capacitor to send a pulse to a two-state solenoid configured to actuate a permanent magnet assembly configured to move between an open and a closed position, the permanent magnet assembly comprising a stopper configured to seal at least one orifice of a pressure locking chamber when in the closed position.

18. The method of claim 17, further comprising maintaining the permanent magnet assembly in the closed position until the control signal rises above the predetermined level.

19. The method of claim 17, further comprising determining whether the control signal has risen above the predetermined level, and when the control signal rises above the predetermined level, triggering the capacitor to send a pulse to the two-state solenoid to move the magnetic assembly to the open position and unseal the at least one orifice of the pressure locking chamber.

20. The method of claim 19, further comprising maintaining the permanent magnet assembly in the open position until the control signal falls below the predetermined level.
